(19) United States
(12) Patent Application Publication
(10) Pub. No.: US 2001/0025274 A1
(43) Pub. Date: Sep. 27, 2001

(54) Method and apparatus for supplementing mailing transaction costs

(76) Inventors: Wilson Zehr, Aloha, OR (US); Mojy Mirashrafi, Portland, OR (US)

Correspondence Address: COLUMBIA IP LAW GROUP, PC, 4900 SW MEADOWS ROAD, SUITE 109, LAKE OSWEGO, OR, 97035, US

(21) Appl. No.: 09/781,129

(22) Filed: Feb. 9, 2001

Related U.S. Application Data
(63) Continuation-in-part of application No. 09/581,306, filed on Jul. 7, 2000.

(51) Int. Cl. G06F 17/60; G06F 17/00; G07B 17/02

(52) U.S. Cl. 705/402; 705/14

(57) ABSTRACT

An electronic-to-physical mail delivery system is provided to receive an indication to send to send a message to a number of recipients. From the number of recipients, a monetary cost associated with sending the message is determined. The system determines if an insertion of an advertisement of a selected one of a link to an advertisement of an advertiser and the advertisement itself, the advertisement having a monetary value associated with it, is received. If the insertion of the advertisement having the monetary value is received, the system automatically reduces the monetary cost associated with sending the message by the value of the inserted advertisement. As a result, a user may send a message electronically to a number of recipients included within a group and have the recipients receive the message as a physical mailing, while supplementing the costs associated with mailing the message by inserting advertisements into the message.

### RELATED APPLICATIONS

The present application is a continuation-in-part application of (a) U.S. patent application Ser. No. 09/581,306, which is national application of PCT Patent Application No. PCT/US00/07093, filed Mar. 17, 2000, which claims priority to U.S. Provisional Application No. 60/125,260, filed on Mar. 19, 1999. These applications are all hereby fully incorporated by reference.

### FIELD OF THE INVENTION

The present invention relates to the fields of mass mailing and electronic advertising. More specifically, the present invention relates to supplementing mailing transaction costs with third party advertisements.

### BACKGROUND OF THE INVENTION

With advances in integrated circuit, microprocessor, networking and communication technologies, increasing number of devices, in particular, digital computing devices, are being interconnected together. The increased interconnectivity of computing devices have let to wide spread adoption of various network dependent applications, such as e-mail and the world wide web.

Along with this increased interconnectivity comes increased usage of the interconnecting communication devices to send and receive communications. Often times, a sender may send a message to a group of more than one recipient at one time. Provided that the message to the group is sent electronically as an e-mail message and the recipients of the group are able to receive the message electronically as e-mail message as well, sending the message to the group is relatively simple and inexpensive. However, if the group was to receive the message in a physical form, the costs associated with sending the message to the group can be very high.

For example, even with the availability of e-mail, often times, a sender of a Christmas letter will send the letter by physical mail (“snail mail”) because of the traditional and personal nature of the Christmas letter. Depending upon the number of family and friends, the costs associated with sending the Christmas letter by “snail mail” may be very high because of the paper, envelopes, and stamps associated with “snail mail”.

Another example would be a doctor's office sending mailings to a number of patients to inform them of information regarding the doctor's practice, such as, for example, a move of the offices and so forth.

Both examples require the need to send a single message to a large number of people as physical mailings increasing the costs associated with the mailing transaction.

Accordingly, a need remains for a mailing system that integrates the advantages of both the Internet and the Web (World Wide Web) with that of the more traditional mail services to improve the dissemination of information from a sender to a large number of recipients while supplementing the costs associated with the mailing transaction for the sender.

### BRIEF DESCRIPTION OF THE DRAWINGS

The invention is illustrated by way of example and not by way of limitation in the figures of the accompanying drawings, in which the like references indicate similar elements and in which:

FIG. 1 is a block diagram illustrating an electronic message to physical mail delivery 25 system according to a preferred embodiment of the invention;

FIG. 2 is a block diagram of software components of the Zairmail system;

FIG. 3 is a flow diagram of the query engine shown in FIG. 2 adapted to select an appropriate local production facility (LPF) according to a preferred embodiment of the invention;

FIG. 4 is a block diagram of software components of the Zairmail mail object compiler 30 implemented according to a preferred embodiment of the invention;

FIG. 5 is a flow diagram illustrating the process steps for selecting appropriate directed advertising content to include within the mail object;

FIGS. 6A-6E are lists of advertisers sorted according to one embodiment of the invention;

FIGS. 7A-7D illustrate different arrangements in which advertisements can be placed on according to the invention;

FIG. 8 is a block diagram of an LPF according to a preferred embodiment of the invention;

FIGS. 9A-9E illustrate an example end user interface suitable for use to practice the e-mail sender aspect of one embodiment of the present invention for supplementing mailing costs;

FIG. 10 illustrates an address table suitable for sending a message to a number of recipients included within a group, in accordance with one embodiment of the present invention;

FIG. 11 illustrates a number of sample tables suitable for storing the previously described category, advertiser, advertisement information, and values associated with each of the advertisement information, for practicing the present invention, in accordance with one embodiment; and

FIG. 12 illustrates the operational flow of the relevant aspects for supplementing the costs associated with mailing a message by inserting advertisements into the message, in accordance with one embodiment of the present invention.

### DETAILED DESCRIPTION OF THE INVENTION

In the following description, various aspects of the invention will be described. However, it will be apparent to those skilled in the art that the invention may be practiced with only some or all aspects of the invention. For purposes of explanation, specific numbers, materials and configurations are set forth in order to provide a thorough understanding of the invention. However, it will also be apparent to one skilled in the art that the invention may be practiced without the specific details. In other instances, well known features are omitted or simplified in order not to obscure the invention.

Parts of the description will be presented in terms of operations performed by a computer system, using terms such as data, flags, bits, values, characters, strings, numbers and the like, consistent with the manner commonly employed by those skilled in the art to convey the substance of their work to others skilled in the art. As well understood by those skilled in the art, these quantities take the form of electrical, magnetic, or optical signals capable of being stored, transferred, combined, and otherwise manipulated through mechanical and electrical components of the computer system, and the term computer system include general purpose as well as special purpose data processing machines, systems, and the like, that are standalone, adjunct or embedded.

Various operations will be described as multiple discrete steps in turn, in a manner that is most helpful in understanding the invention, however, the order of description should not be construed as to imply that these operations are necessarily order dependent. In particular, these operations need not be performed in the order of presentation.

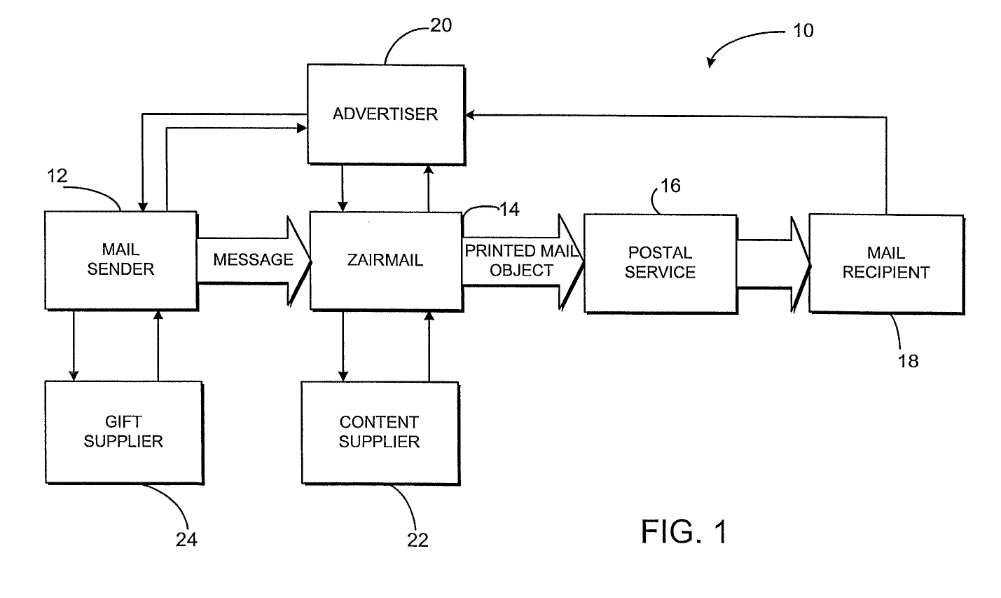

FIG. 1 is a block diagram of an electronic message to physical mail delivery system 10 implemented according to a preferred embodiment of the invention. The system contemplates a mail sender 12 preparing an electronic message which is then processed, shunted to an appropriate printing facility (chosen based on such attributes as proximity to the intended recipient of the message, capacity, capability, etc.), and then printed out by system 14 (Zairmail system). A printed mail object including the message is then delivered to the postal service 16 or other like organization/company for physical delivery of the printed object to the intended mail recipient 18. Although the invention is directed primarily to traditional printed messages, the system herein described can be used in conjunction with any items on which specified printed materials appear, such as T-shirts, posters, mugs, etc.

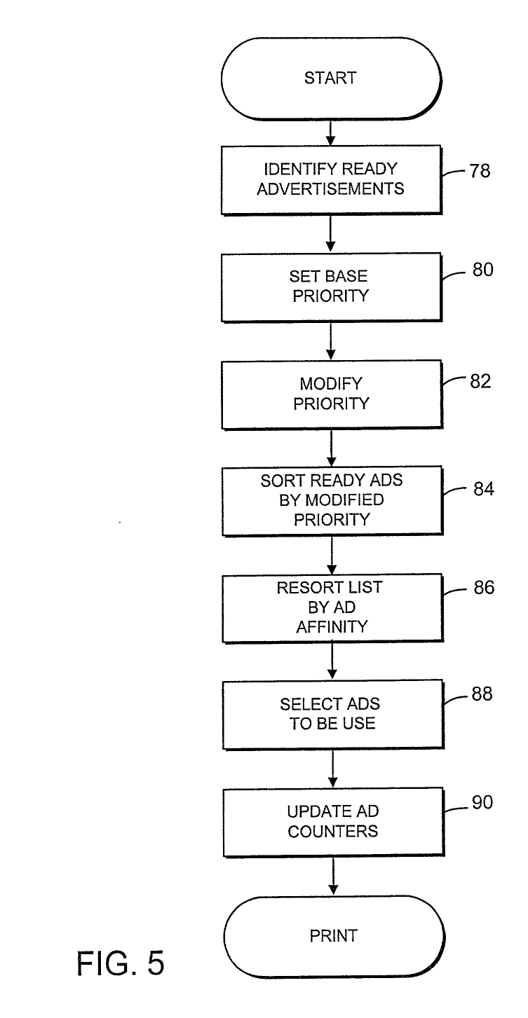

System 10 contemplates supplementing mailing costs through advertising content from advertisers 20 placed within the printed mail object. The selection and placement of appropriate advertisements within the printed message forms an additional portion of the inventive physical mail delivery system 10 and is described in more detail below with reference to FIGS. 5, 6A-6E, and 7A-7D. Further content can be added to the message supplied from value-added content providers 22. The value-added content to the message can for example include limited edition artwork, joke or cartoon of the day, crossword puzzles, and others. As contemplated within an embodiment of the invention, the mail sender 12 can accumulate points for using the Zairmail system which can then be exchanged for goods or services, as from gift supply partners 24, advertisers 20, or others.

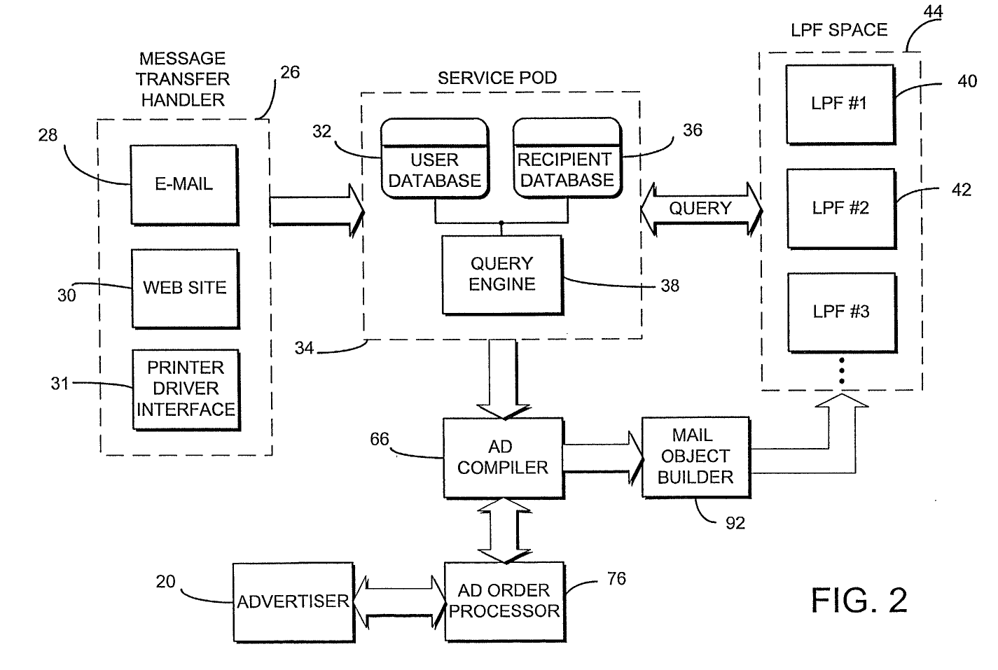

The mail sender 12 can compose and send messages electronically to the Zairmail system 14 in three different formats. Referring to FIG. 2, the message can be intercepted at an intermediate node such as message transfer handler 26 of the Zairmail system 14 by an e-mail subsystem 28, via web site interface 30, or through the printer driver interface 31.

Turning first to the e-mail interface, a user composes an e-mail message and addresses the e-mail to a recipient at a particular domain, e.g. recipient id “mom” at e-mail domain “zairmail.com”. The e-mail message sender is identified by the “From” line of the e-mail message and the recipient's physical address and other demographic statistics are looked up in a user database 32. The particulars of this type of physical address look-up system are not disclosed here as such a system can be constructed with reference to U.S. Pat. No. 5,805,810.

The second type of interface contemplates a mail sender logging onto a Web site located on a server of the Zairmail system 14. The mail sender can store a personalized address book within a user database 32 for use and retrieval later. Once logged on to the system, the user is presented with a blank form in which he or she can designate a recipient, the text of the message, select whether and which advertisements to include within the printed mail object, select whether to send printable coupons, and other items. Delivery options, such as certified mail, registered mail, overnight or immediate delivery, or message archiving, can also be specified by the Zairmail system user.

The printer driver interface 31 interacts with printer drivers downloaded to the user's machine. Any printing to the devices represented by Zairmail printer drivers will be sent to the printer driver interface for processing. The users can use anyone of their desktop applications to compose a message, and print it to the Zairmail printer. When the user is connected to the Internet, the Zairmail printer drivers will then connect to the printer driver interface 31 and transmit the message on to service pod 34.

The service pod 34 operates to select the appropriate Local Production Facility (LPF) to which the electronic message is shunted and ultimately printed out for mailing with the U.S. Post Office or similar physical mail delivery service. The service pod includes user database 32, a recipient database 36 and a query engine 38. The user database 32 includes address book information for the mail sender 12 in order to generate physical address information used by the query engine. The user database can store archived messages sent over a particular time period. The recipient database 36 includes information on the recipient such as personal demographics and whether that particular recipient has opted to block messages sent through the Zairmail system 14, block certain advertisements from being attached to messages sent through the Zairmail system, or block messages sent from a particular user of the Zairmail system. Demographic information for the receiver is compiled internally, as by querying the receiver's profile as listed within the user database 32, and externally from external data sources such as those available through Experian Information Solutions, Inc. Information within the recipient database is periodically queried to generate accompanying printed material with the electronic message, such as directed advertisements, as discussed further below.

Query engine 38 operates to query distributed LPFs, such as LPF 40 and 42, geographically separated within LPF space 44, and determine their appropriateness for the job of printing the electronic message in physical form. By way of example, LPF 40 may be located in San Francisco while LPF 42 may be located in New York City. In the alternative, the LPFs may be located in different countries so that an electronic message originating within one country can be printed and mailed in the recipient's country in order to avoid air-mail charges. Mail printed and mailed at a post office proximate to the recipient's physical address will often result in improved delivery times since cross-country transport of the physical mail object would not then be necessary. In this way, the electronic message may be quickly and inexpensively delivered via a physical mail delivery system.

It must be noted that the actual physical proximity of the LPFs to the destination address may not actually result in the fastest delivery time. There may be expedited means of transferring mail from other LPFs to the destination, based on perhaps scheduled point-to-point flights from LPF location to the destination location. So, if the messages are printed in an LPF within the cutoff time of reaching the scheduled flight, we might be able to deliver the messages faster than sending the message to an LPF that would miss the next day delivery deadlines.

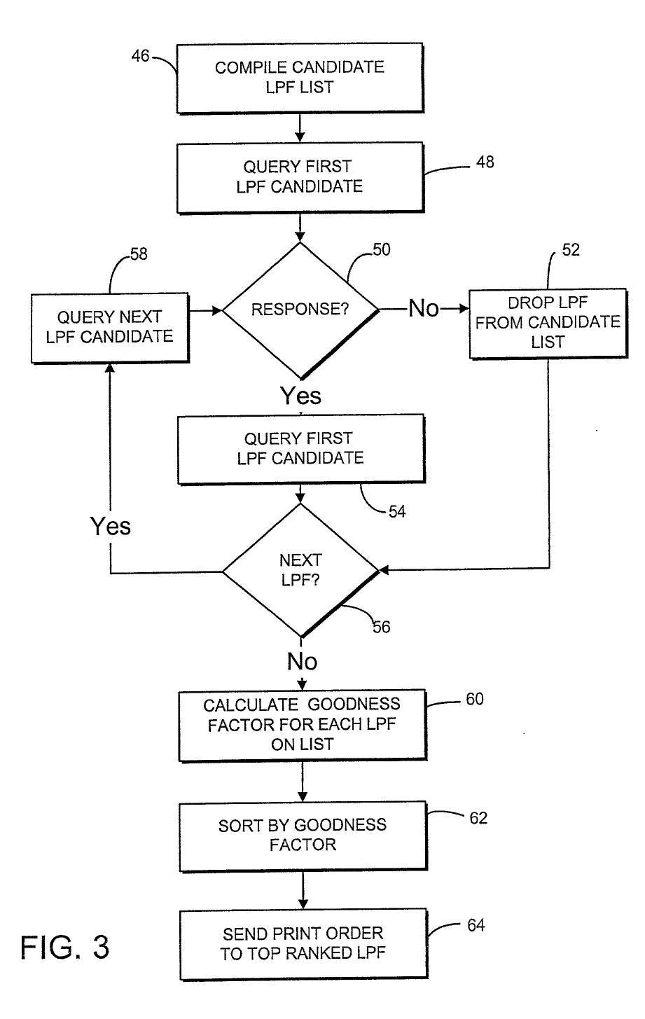

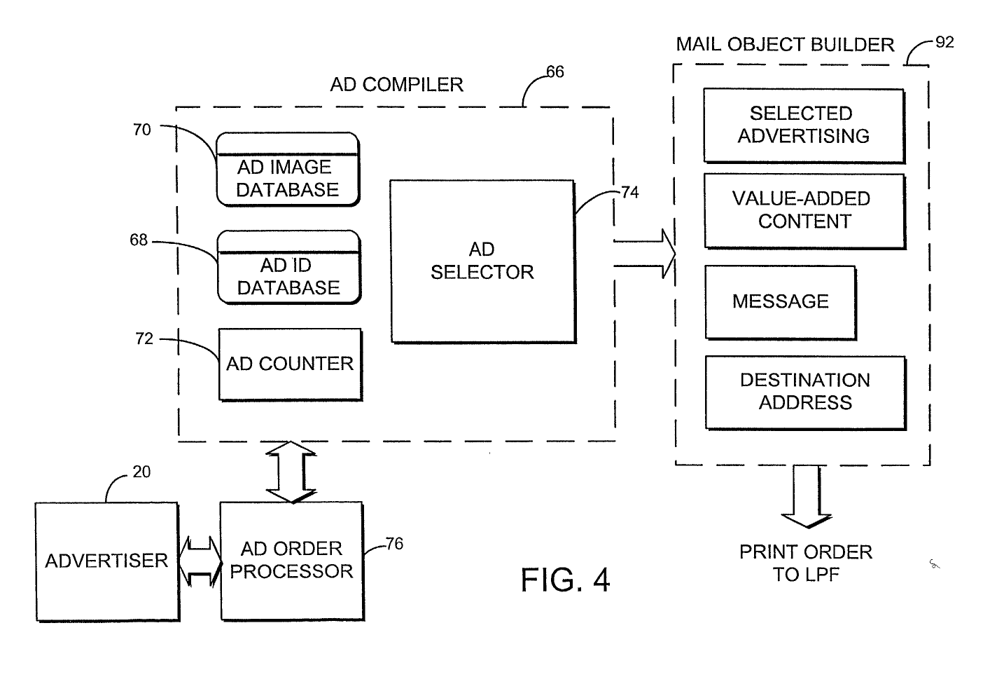

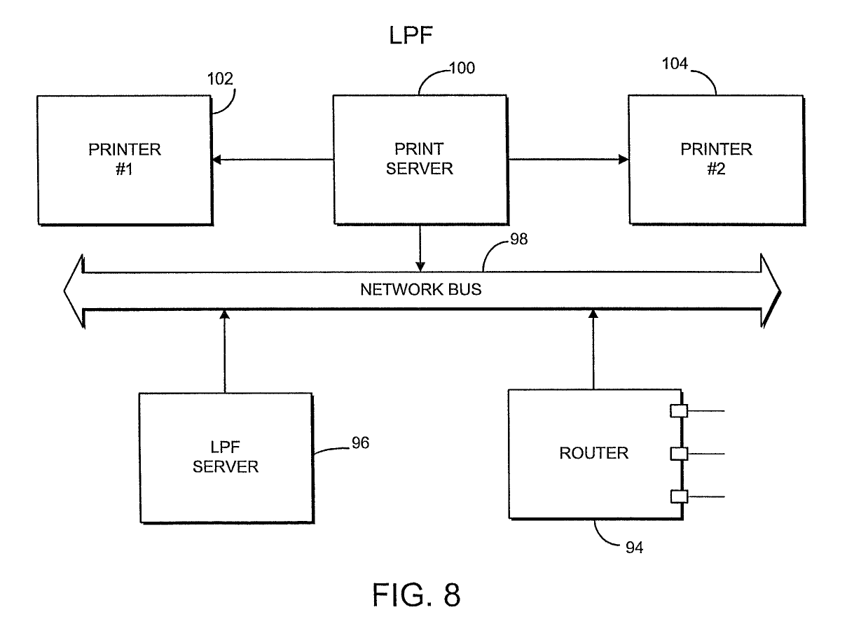

FIG. 3 illustrates steps undertaken by the query engine 38 to determine the most appropriate LPF. A candidate list of possible LPFs is compiled in step 46. These are LPFs with the type of equipment available, such as shown in FIG. 8, to communicate with the mail object builder 92 of FIG. 4 and are typically included within a static table stored within memory of the query engine. The list can be further limited to only those LPFs within a certain distance of the recipient's address or some other factor such as expedited delivery mechanisms. The query engine 38 then queries each candidate LPF to determine whether it is appropriate for the printing job. The first LPF candidate is queried in step 48. The query is a request for information regarding the current capacity and capabilities of the LPF-attributes that may change over time and cannot necessarily be quantified in a static table. The first LPF is given a certain amount of time to respond to the electronic query in step 50. If it does not respond within the allotted time, the LPF is taken off the candidate list in step 52. If it does respond, then the requested information is retrieved in step 54, and processed in later steps to determine a “goodness factor” as disclosed below. If not all LPFs on the list have been queried as determined within step 56, then the process moves to step 58 in which the next LPF on the list is queried. The process continues until a modified candidate list is generated and information from each of the LPFs on the list retrieved. If it is determined in step 56 that all LPFs on the candidate list have been queried, then the process moves to step 60. All LPFs can likewise be queried simultaneously using a message broadcast to each of the LPFs so that development of the modified candidate list can be done in parallel.

In step 60, a “goodness factor” is determined for each LPF on the modified candidate list based upon attributes of the LPF that might affect that LPF's ability to successfully carry out the requested print job on time. Examples of such attributes include proximity to the deliver point (zip code), the capability of the printers and other facilities in the LPF (can it actually do the job, e.g., print materials [paper, T-shirts, posters] with the appropriate color and size available), the LPF capacity (the estimated lag time for job completion), the cost bid by the LPF per impression, and the shipping capability to the post office (how fast the printed mail object can be delivered to the post office). The ideal LPF would be the closest, physically or by means of expedited delivery mechanisms, to one to the final destination with the right equipment and supplies to complete the job and a very low time-to-print lag. Less desirable LPF factors that are communicated to the query engine responsive to the LPF query can include situations where the LPF is down either because of equipment failure or connectivity problems, the LPF may be loaded down with lots of jobs, the LPF may not have the proper facilities and/or supplies to complete the print job, and the vehicles and people may not be available to deliver the messages to the Post Office. An enhanced implementation of an LPF selection for larger jobs could be that LPFs may compete for a particular job based on available (otherwise wasted) capacity and capability as well as having “insert” advertisements that need to be sent for high-paying advertisers.

The cost attribute can be changed by the LPF operator via a web interface with service pod 34 to change one or more static attributes stored within and considered by the query engine 38 when selecting the appropriate LPF to send the print order to. In the alternative, the LPF operator can enter or modify the cost attribute (e.g. the amount of money the LPF will charge to complete a certain task such as printing a full color, two-sided greeting card, sorting, processing, stamping, and delivering to the Post Office) locally at the LPF server 96, which communicates with the service pod 34. The LPF attributes are stored within an attribute database at the LPF server responsive to automatic queries within the local network of equipment at the LPF site as well as manually entered data. For instance, if an LPF facility is running at low capacity, the LPF operator can lower his bid to complete certain types of jobs, thereby increasing his LPF's goodness factor and improving the chance that his LPF will be selected to perform a certain print command by the query engine 38.

Once the goodness factor has been calculated for each LPF in step 60, the LPFs on the modified candidate list are sorted in step 62 to determine the LPF with the highest goodness factor—that is, the most appropriate LPF for the print job and delivery of the printed mail object to the post office. The print order (compiled according to the methods and systems described below) is then sent electronically to the top ranked LPF in step 64.

The advantage of such a querying system over prior art systems, such as in U.S. Pat. No. 5,805,810, is that many dynamic factors can be taken into consideration before shunting the print order to the appropriate LPF. In this was, the present system will not send messages for printing to print facilities that are off-line, without capacity, or without the capabilities to carry out the job. The NetGram-based transmission system, for instance, will keep attempting to deliver to the off-line print facility until the facility is again operational or a time-out occurs, in which case the message may not ultimately be delivered, or delivered late.

FIG. 4 illustrates in block diagrams the components for building the mail object. The ad compiler is shown at 66 and includes an advertisement image database 68, an advertisement ID database 70, ad counter 72, and an ad selector 74. The advertisement image database 68 stores the graphical representations of advertisements and can be accessed and updated with new images by advertiser users with the proper permissions as described in more detail below. The advertisement ID database associates in a lookup table each image with an ill number so that when the mail object is constructed and electronically transmitted to the LPF for printing, the size of the transmitted mail object can be reduced since the ID and not the graphic image file only need be transmitted. As will be appreciated, the graphic images are stored locally at the LPFs so that the proper images can be substituted where indicated by the ill immediately prior to printing. The ad counter 72 compiles statistics from the ad selector to keep track of how many of each advertisement is used and to complete accounting so that the particular advertiser can be charged.

The ad compiler is coupled to an ad order processor 76 that operates as follows. A participating advertiser will login and the Zairmail system will authenticate their user ill and password. Each advertiser can have multiple groups, each with different permissions. Each group can further have multiple users, each of those with different permissions. Permissions will apply on a personal, group, or advertiser basis. Within each of these groups, “read”, “modify”, “delete”, and “order” permissions will be available. Each advertiser must have at least one super-user—a user who has full privilege to read, modify, delete, or order. The super-user is responsible for adding or deleting users, and assigning permissions, for preapproved corporate accounts. An advertiser user can, with the proper permissions, place or change orders corresponding to the preferred target market the advertiser would like to direct their marketing to, the price they are willing to pay for advertising directly to a particular mail recipient (supplementing the mailing costs), or to change the advertising graphics stored within the ad image database 68. The advertising user can select demographic variables, time frames in which the advertisement is active, and the maximum number of impressions per receiver and over a particular time-frame. By way of example, an advertiser for a luxury car company can choose to advertise only to those individuals living in ZIP codes wherein the average home prices is over $300,000. By using both internal and external databases, such limitations can be addressed. Advertiser-set limits are stored within the ad selector 74 and used in the processing steps discussed below to select the most appropriate and lucrative advertising content to include within the mail object.

The ad selector 74 operates in conjunction with the advertisement databases 68, 70 and ad counter 72 to determine which advertisements will be printed. The ad selector can also operate in conjunction with the recipient database to prevent repeat impressions of the same advertisement with the same recipient within a certain period of time. One method for selecting advertisements is shown in FIG. 5 in which the universe of ready advertisements stored in the system are identified in step 78. These ready advertisements are those that have not expired, with a current print count stored within the counter 72 less than the print count paid for by the advertiser. Each advertisement has a base priority associated with it (step 80) that, for instance, can be based on how much the advertiser has paid for the space. The higher the amount paid, the higher the priority. Size of the advertisement can be factored in to this base priority as well as well as factors considering whether certain ads are set to expire sooner than others (so that the ad limits can be used prior to expiration). This base priority can be modified in step 82 according to how closely the mail recipient 18 matches the target market pre-selected by the advertiser through the ad order processor 76. The ready ads are sorted by their modified priority in step 84 to yield a modified ad list.

Finally, the ads on the modified ad list are sorted a second time by ad affinity in step 86. Ad affinity operates by, for instance, looking at the ads located above and below the particular ad on the modified list and apply pre-established factors based, not on the designated mail recipient, but on the advertisements that would also appear on the mail object with the one ad. For instance, the listing of an advertisement for a clothing store in the top slot of the modified list may act to negatively affect the co-listing on the mail object of an ad for a competing clothing store. Likewise, an ad for a health food store can elect not to ever be listed with advertisements for alcohol or tobacco products. Ad affinity can also be established to positively influence the chance that a certain type of advertisement, such as a car rental ad, will be paired with another type of ad, such as an airline ad, in either the same mail object or to the same recipient over a period of time.

Other factors that can affect the priority is the willingness of an advertiser to “bid-up” for a spot -meaning whether an advertiser has indicated within the ad order processor 76 that placement of certain ads to certain types of people are worth more than others. This is indicated as one of the attributes of the advertisement as well as what the bid increments are and the ceiling value for the bid. If no ads match the demographics for a particular recipient, the ad compiler 86 operates in one embodiment of the invention to pick from low-priority or default advertisers that pay very little or non-profit, community service or interesting articles, that are willing to wait until no other high-paying ads are competing for the space.

One issue that may occur under the present system is starvation—that is, the chance that certain low-bid ads will never be printed and may be intentionally locked out by competing advertisers. A “fairness” routine is then employed by the ad compiler 66 to ensure that a few number of very high-paying advertisers cannot block other advertisements from being printed. One example of an implementation of the fairness routing is where the base priority of all losing advertisements are incremented so that their chance of being chosen in a subsequent selection round is increased. An alternative is providing a “rest-period” for advertisements, where after a certain number of “wins”, the advertisements are taken out of the ready advertisements group and are required to rest for a few rounds before they are again qualified to participate in the ad selection process.

Once the modified list is reorganized by factoring in ad affinity, then the appropriate number of ads are selected and placed on the mail object document in step 88 and the ad counter 72 is updated in step 90 to reflect that certain ads were used. It should be noted that similar ad selection processes can be used in selecting advertisements for display on a web page, as in a banner ad, and should not be limited simply to print advertisements.

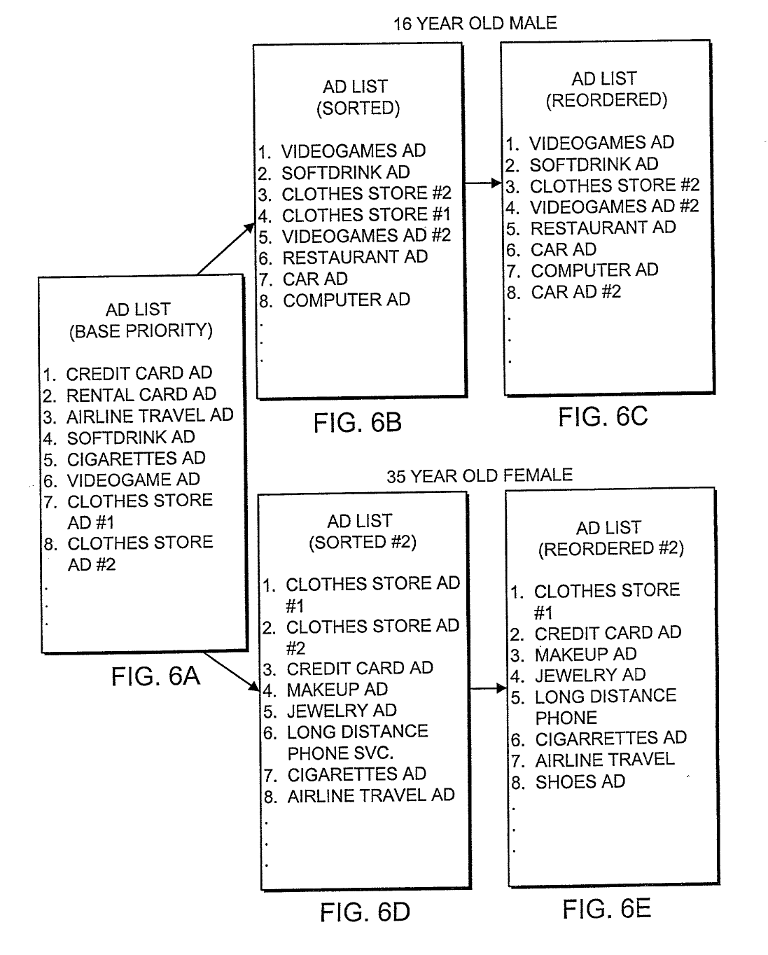

The tables in FIGS. 6A-6E illustrate how ad affinity may be. Applied according to one embodiment of the invention. A basic ad list, sorted according to base priority, is shown in FIG. 6A. FIGS. 6B and 6D show a modified list sorted responsive to demographics known about the mail recipient. In the examples shown, FIG. 6B is a modified ad list targeted at a sixteen-year-old male; while FIG. 6D is a modified ad list targeted at a 35-year-old female. Note, for instance, that the ads are skewed toward the interests of the particular demographic—FIG. 6B having two videogame listings in the top eight ads and FIG. 6D having the top two spots taken by clothing advertisements. FIGS. 6C and 6E show the modified list of FIGS. 6B and 6D, respectively, as further modified by ad affinity. In FIG. 6C, for instance, the VideoGame#2 ad was not rejected on affinity because the video game advertiser did not specify the rejection. However, the ClothingStore#1 ad was dropped from the list because the advertiser for ClothingStore#2 chose not to be listed with another clothing advertisement. Similarly, in FIG. 6E, the ClothingStore#1 advertisement in the top spot specified an affinity rejection of the ClothingStore#2 advertisement which was dropped from the list and the remaining advertisements consequently are moved up on the list.

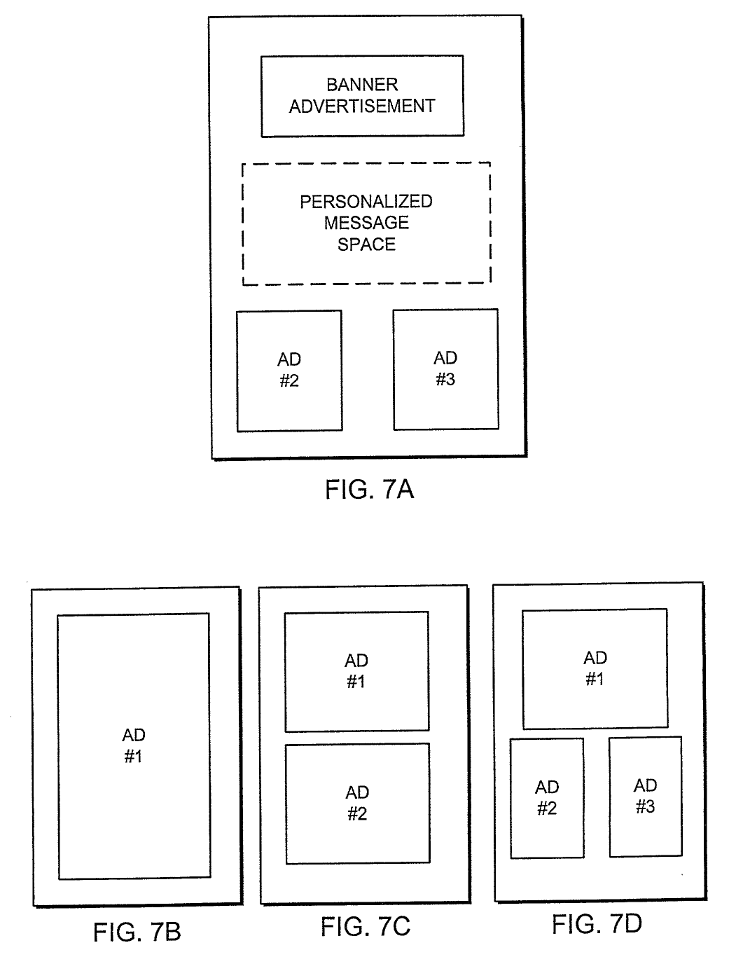

Turning back to FIG. 4, the selected advertisement IDs, any value-added content the message and the recipient's address are sent to the mail object builder 92 so that the various components can be arranged on a page. An example of how certain selected advertisements can be arranged on a page of a printed mail object is shown in FIG. 7A. Once the type and designated number of advertisements are selected, they are placed on the mail object which in this case comprises a standard sheet of letter-sized paper. FIG. 7A shows three advertisements arranged about the space containing the text of the electronic message. FIG. 7B shows a full-page ad view. FIG. 7C shows two half-page advertisements. And FIG. 7D shows one-half page and two quarter page advertisements. Each position and size on the page can have an associated price that is applied to the mailing costs to supplement or completely eliminate the mailing costs required of the mail sender. Once arranged in a printable format, such as by constructing a file using any standard desktop publishing program, the mail object is sent along with a print order to the LPF designated in step 64.

FIG. 8 is an example of an LPF server, including a router 94 through which information is exchanged with the service pod 34 (FIG. 2) and mail object builder 92 (FIG. 4). An LPF server 96 includes a storage system on which advertisement graphics files are located associated with the advertisement ID numbers included with the mail object. Also included on LPF server is an attribute processor (not shown) that periodically queries over the network bus 98 the status and capabilities of the print server 100 and other external and internal attributes requested by the service pod 34. The print order from the mail object builder 92 (FIG. 4) is processed by the LPF server, including inserting advertisement and other graphics where indicated on the mail object document, to form a printable mail object. Such an object is sent to the print server 100 where it is shunted to one of the printers 102, 104 with the capability of printing the mail object as requested. Once printed out, the mail object is addressed and sealed in an envelope and carried to the local post office for delivery by normal land-based means to the intended mail recipient.

The LPF software will use all available techniques to achieve as much discounts as possible for each message. The messages will be sorted based on local delivery regulations and guidelines for maximum discounts and delivery accuracy. Such technologies are: CASS (Code Accuracy Support System) where each address is checked and verified to be a valid address, PAVE (Presort Accuracy, Validation, and Evaluation) to pre-sort the addresses for expedited delivery and maximum discount, ACS (Address Correction Service), and NCOA (National Change of Address).

Now that the individual components of the Zairmail system have been described, attention is given back to FIG. 1. The mail sender 12 is serviced by the Zairmail system 14 by allowing electronically composed messages to be sent to a recipient who can receive physical mail but may not have the ability to receive the electronic message in its native form. “Frequent user points” may be awarded based upon the number of messages sent, where points can be exchanged later for other goods and services. The mail sender 12 interacts with advertisers 20 by viewing the ads selected for placement on the mail object. The sender has the option of previewing the ads and choosing if the ads should be sent or not to the recipients—thus, these ads are also viewed by the mail recipient 18. Should the receiver purchase products from the advertise responsive to advertising directed to the mail recipient at the mail sender's behalf, the mail sender can receiver additions “frequent user points” or gifts. The value-added content suppliers 22 gain exposure and, in some cases, payment for the content they provide while the Zairmail system 14 gains increased mail volume by providing more attractive content for its mail users. Advertisers 20 gain market data and impressions at their Web site while the Zairmail system gains ad content and, most importantly, exchanges ad exposure for money to supplement and sometimes exceed the costs of the printing and mailing costs.

In addition to using value-added content and artwork to drive volume, other promotional tools can be used. In one example, frequent mailer contests will award gifts to those users who mail at least a certain number of messages. In another example, each message sent through the system according to the invention can include a puzzle piece that can be collected and combined with other puzzle pieces to win a prize. This promotion can be applied to the mail sender as well.

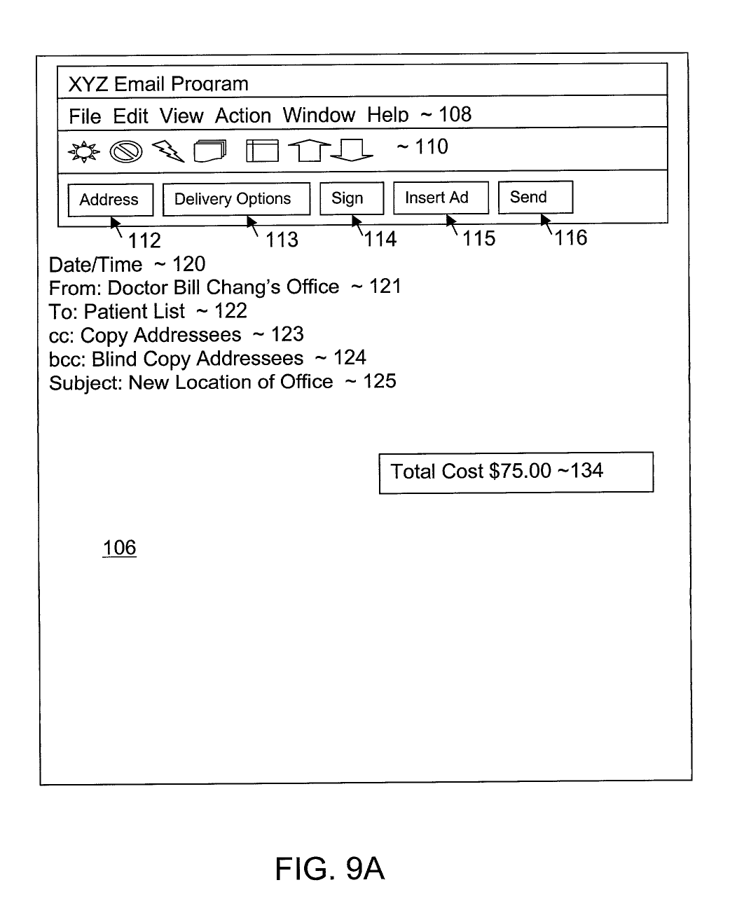

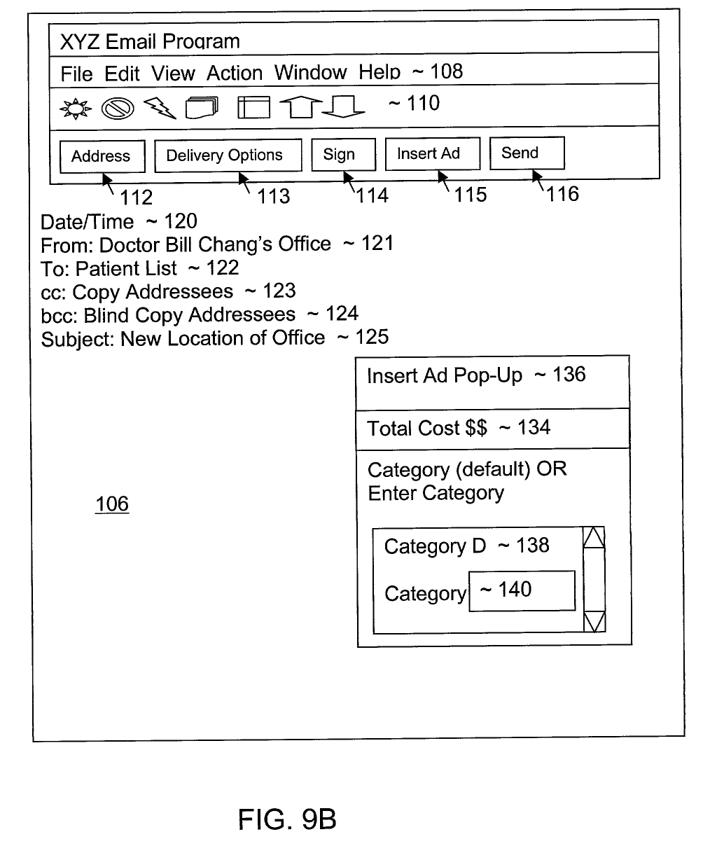

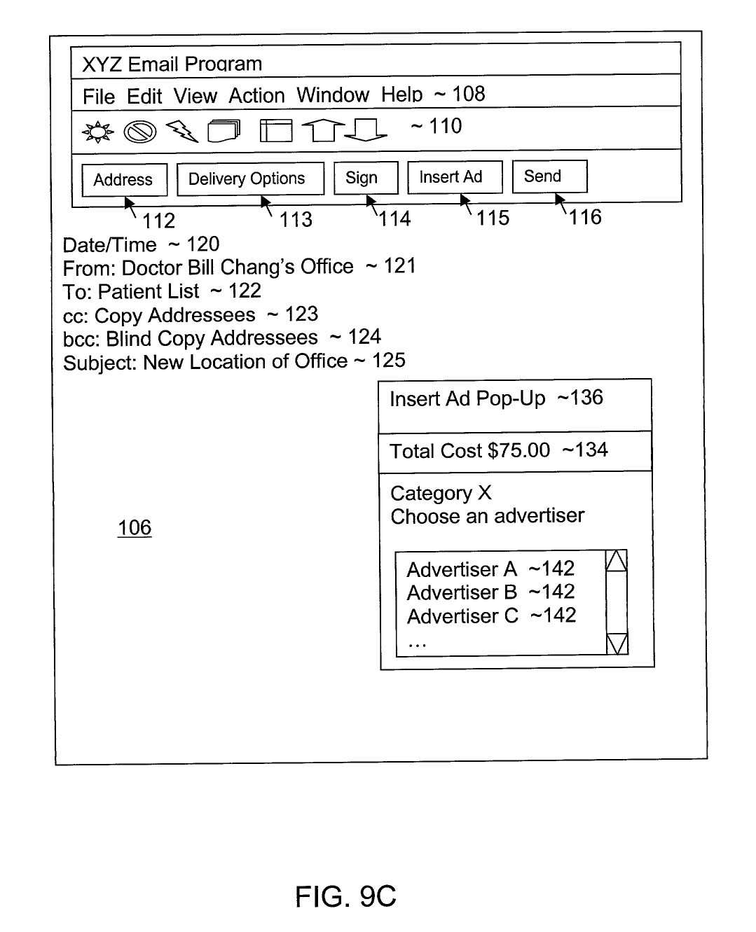

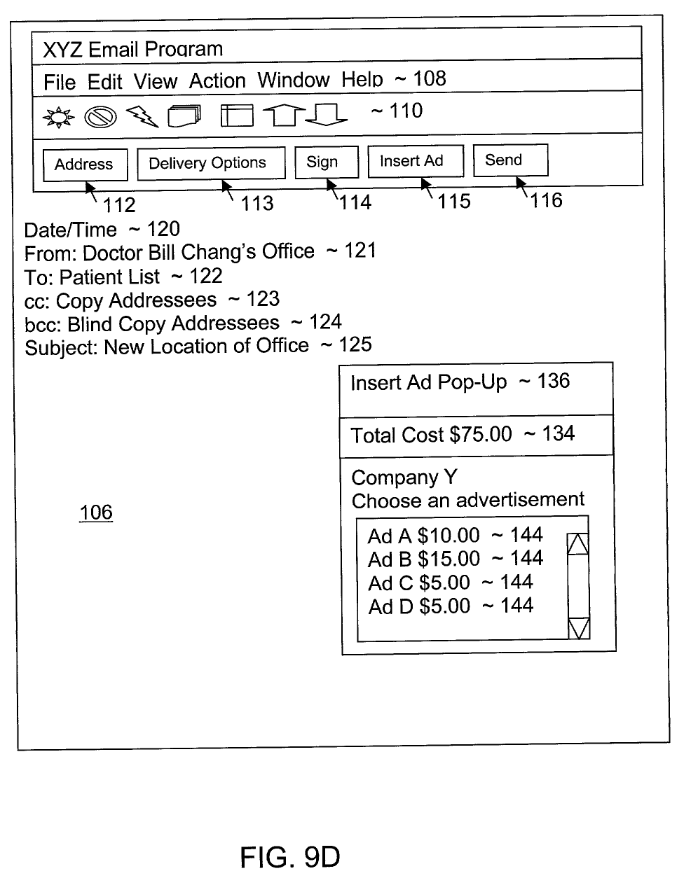

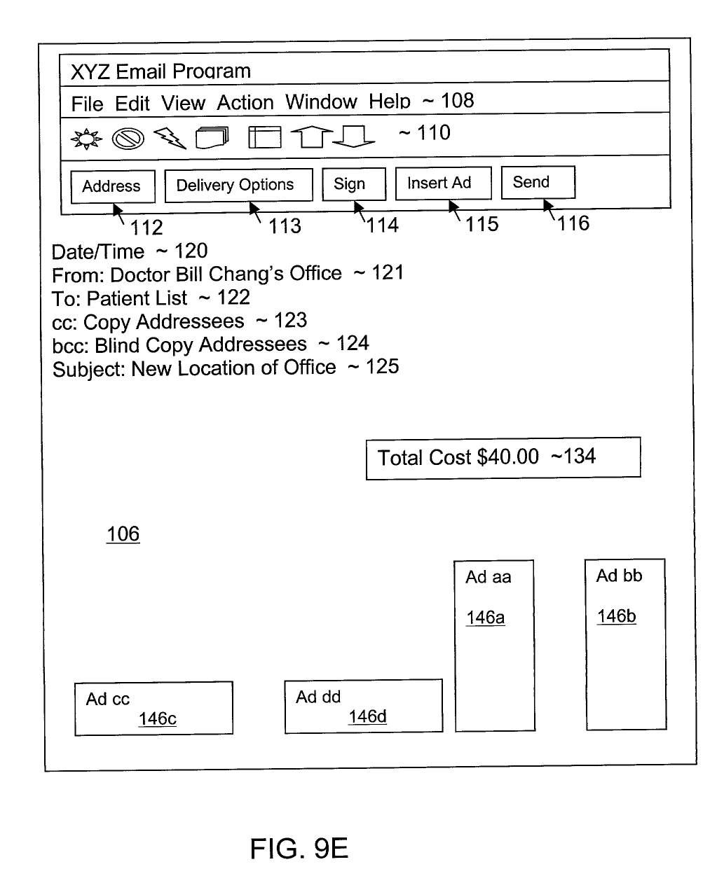

FIGS. 9A-9E illustrate an example end user interface suitable for use to practice the e-mail sender aspect of one embodiment of the present invention for supplementing mailing costs. Referring to FIG. 9A, similar to e-mail end user interfaces known in the art, such as, for example, e-mail messaging window. The end user interface 106 includes menu 108 of “drop down” commands, i.e., “File”, “Edit” and so forth menu 108 of action icons, a number of command buttons 112-116, “Date/Time”, “From”, “To” and copy addressee fields 120-125.

As previously described, the user composes an e-mail message and addresses the e-mail to a recipient at a particular domain, in the one embodiment shown, for example, recipient id “patients” at e-mail domain “zairmail.com”. The e-mail message sender is identified by the “From” line of the e-mail message and the recipients' physical addresses and other demographic statistics are looked up in the user database 32.

In the one embodiment shown in FIG. 9A, the “To” line of the e-mail message designates a group 122 of recipients, such as, for example, a number of recipients included in the group for Doctor Bill Chang's patient list, and this group 122 may be stored in the user database 32. The sender (not shown) may compose the message, for example, a message notifying the recipients of the group 122 that the doctor's office has been moved, as an e-mail message. The message is sent as physical mailings to all the recipients included in the group 122, sender's patient list, stored in the user database 32.

Demographic information associated with recipients included within the group 122 may include information corresponding to the type of practice of Dr. Chang, such as, for example, Dr. Chang may be a pediatrician, and parents of youths may be the demographic information associated with the group 122, and this demographic information may be may be stored in the recipient database 36 as well as the user database 32. From the demographic information, the physical mailings of the message may include printing the message on decorative paper, envelopes, and so forth to promote a children oriented theme.

Shown in FIG. 9A, the costs associated with the printing and mailing of the message to the group is automatically determined and displayed as a “Pop-Up” window displaying $75.00, such as, for example, cost window 134, in accordance with the present invention. The user may select the “Send” command button 116, and in response, the message to all of the recipients in the group 122 is sent. Furthermore, the user is billed for the mailings corresponding to the amount displayed in the cost window 134. Alternatively, the user may be prompted for a credit card number for payment. However, under the present invention, as shown in FIG. 9B, the user is offered an opportunity to have all or part of the mailing cost paid for by third party advertisements. In accordance with one embodiment of the present invention, an “Insert Ad” command button 115 is provided for user selection. Upon selection, in response, the end user interface 106 presents an “Insert Ad pop-up” window 136 including the cost window 134.

Shown in FIG. 9B, the “Insert Ad pop-up” window 136 presents an advertisement category 138. The advertisement category 138 may be a default category based at least upon the demographic information associated with the recipients of the group 122, such as, but not limited to, medicine for children category. Additionally presented in the “Insert Ad pop-up” window 136 is a category text entry box 140 into which an inputted advertisement category may be received, and in response, the advertisement category is changed from the default advertisement category 138 to an entered advertisement category, such as, but not limited to, safety equipment for children category. The user may choose the default advertisement category 138 or enter a category in the category text entry box 140.

Referring now to FIG. 9C, in response to the user selecting an advertisement category, the end user interface 106 presents a number of advertisers 142. The advertisers 142 represent advertisers included within the selected advertisement category, such as, for example, the advertisement category, medicine for children, may include advertisers, such as, but not limited to, Johnson & Johnson Corporation.

Shown in FIG. 9D, in response to the user selecting an advertiser, the end user interface 106 presents a number of advertisements 144 for “insertion” into the message, such as, for example, Tylenol Kidcare® and Children's Motrin Drops®. Illustrated in FIG. 9D, each advertisement 144 has a value associated with it, i.e., each advertisement is worth a certain dollar amount to offset the costs associated with the mailing the message to the recipients of the group 122 displayed in the cost window 134. As previously described, the value of the ads may be predetermined by determining that certain ads are to certain types of people worth more than others, i.e., “bid-up”.

Finally, as illustrated in FIG. 9E, in response to the user selection of one or more of the advertisements 144, the one or more advertisements 144 are “inserted” into the message. In the one embodiment shown in FIG. 9E, as the one or more advertisements are “inserted” and displayed as selected advertisements 146a-146d, the cost associated with mailing the message is automatically reduced by the value(s) of the selected advertisements 146a-146d displayed in the cost window 134. In addition to the predetermined value of the advertisements 146a-146d, as previously described, each position and size of the advertisement on the page may also have an associated price. For example, in FIG. 9D, the values of the “inserted” advertisements 146a-146d are $10.00, $15.00, $5.00, and $5.00 respectively, and it follows that once the advertisements are inserted 146a-146d (FIG. 9E), the cost window 134 displays reduced cost of $40.00, i.e., $75.00−($10.00+$15.00+$5.00+$5.00). Furthermore, the sender may continue to “insert” more advertisements from the previously selected advertiser (in the event the initial selection did not bring the residual cost to zero), change advertisers, or change categories and “insert” advertisements from different categories and advertisers. Note that in various embodiments, the mass mailer may even be given positive credits should the values of the selected advertisements exceed the mailing cost. The credits may be saved for the next mailing, or otherwise compensated in a monetary or non-monetary manner.

In one embodiment, it is the selected advertisement itself that is actually “inserted” into the e-mail. In another embodiment, a link to an advertiser 20 (shown in FIG. 1) is “inserted”, where the selected advertisement may be retrieved and inserted at printing time instead.

Alternatively, in one embodiment, coupons may accompany the advertisements. For example, as described with respect to the above advertisements, the “insertion” of a particular advertisement may automatically attach a coupon in the form of a predetermined discount for the particular product of the “inserted” advertisement. This coupon may be in the form of an electronic coupon (e-coupon), where the receiver may redeem the e-coupon when purchasing the product online, or alternatively, this coupon may be in the form of a printable coupon, which the recipient may print and physically take the coupon to a physical location to redeem the printable coupon for the product.

Furthermore, as described with respect to the advertisements above, coupons may be automatically attached to the message even if no advertisement is “inserted”. The advertisements the coupons relate to may be based at least upon the previously “inserted” advertisements, or alternatively, based at least upon the demographic information of the recipients, i.e., a coupon for 50% off toothpaste for a message to patients of a dental office.

Thus, it can be seen from the above description, under the manual “insertion” mode of operation, a user has full control in selecting the kind of advertisements that are included in the mailings and the amount of reduction of the costs associated with the mailings, or alternatively, the advertisement and/or coupons may be selected automatically. The selection process may be repeated as many times as the user desires. In one embodiment, the selected advertisements 146a-146d are automatically arranged along the perimeters of the e-mail as shown in FIG. 9E. Alternatively, the advertisements may be automatically arranged based at least upon each position and size on the page can have an associated price that is applied to the costs associated with the mailings.

As a result, a user may compose a message electronically and send the message to a number of recipients included within a group and have the recipients receive the message as physical mailings, while supplementing the cost associated with mailing the message by inserting advertisements into the message.

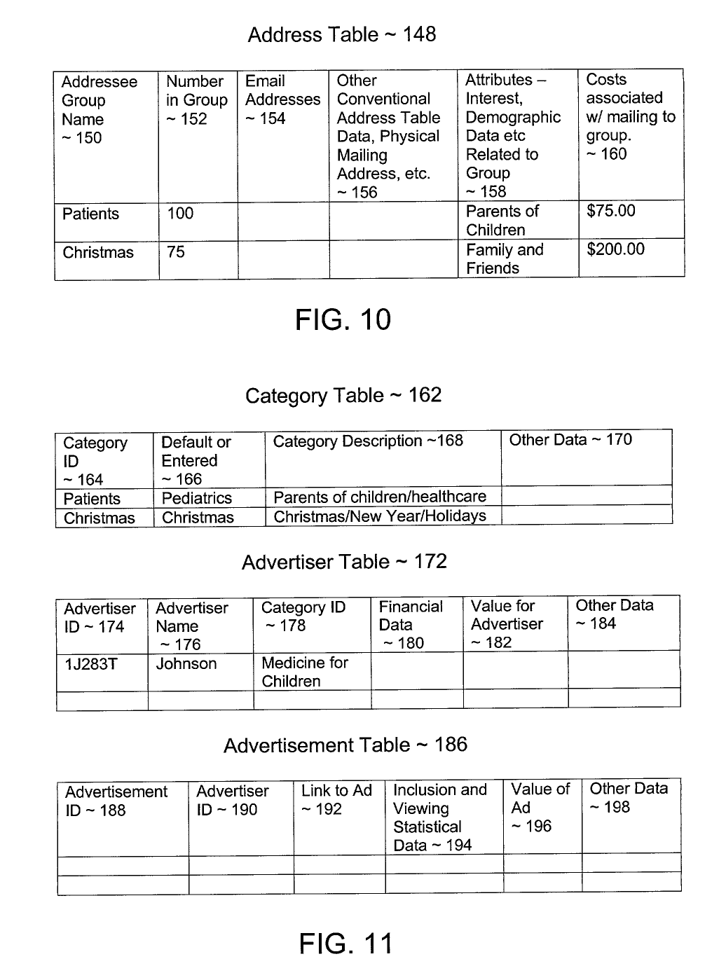

FIG. 10 illustrates an address table suitable for sending a message to a number of recipients included within a group, in accordance with one embodiment of the present invention. Shown in FIG. 10 is an address table 148 with columns for storing addressee group names 150, the number of recipients within the group 152, their e-mail addresses 154 (if applicable), their physical mailing addresses 156, the demographics information associated with the recipients within the group 158, and advantageously, the costs associated with mailing the message 160. This table may be stored in the user database 32 (shown in FIG. 2). Alternatively, in particular, the demographic information may also be stored in the recipient database 36.

As shown in FIG. 10, a user need only select a previously stored address group name in the “To” line of the message of the end user interface 106 to send the message to a number of recipients of the group, such as, but not limited to, address group name 150 “Patients” corresponds to 100 recipients in the number in group column 152, parents of children in the attributes/demographics column 158, and mailing costs $75.00 in the costs associated with mailing to the group column 160. The data within the costs associated with mailing to the group column 160 is included within the cost menu 134, which is automatically generated and displayed in response to the user selecting the previously stored address group name.

FIG. 11 illustrates a number of sample tables suitable for storing the previously described category, advertiser, advertisement information, and values associated with each of the advertisement information, for practicing the present invention, in accordance with one embodiment. The example category table 162 includes column for category ID 166, which corresponds to the attributes/demographics information column 158. Furthermore, included within the table 162 are columns for receiving an entered category 168, category description 170, and other data 172 associated with the advertisement category. For example, the category description column 170 for the addressee group name “patients” may include medicine for children.

Shown in FIG. 11, are an advertiser table, which includes an advertiser ID column 176, an advertiser name column 178, a category ID column 180, a financial data column 182, a value for advertiser column 184, and other data for the advertiser table 186. For example, the advertiser may place a high priority, i.e., the value for the advertiser column 184 is high, for category ID column 180 of medicine for children because of marketing. This may cause the advertiser to “bid-up” for advertisements within this category.

In FIG. 11, example advertisement table 188 includes columns 190 for storing advertisement identification, columns 192 and 194 for storing advertiser identifications of the advertisements and links to the locations where the advertisements may be retrieved, and column 196 for storing at least various statistical data associated with the publishing of the advertisements. Additionally, for the illustrated embodiment, advertisement table 188 also includes column 198 for storing the value associated with the advertisement. For example, certain advertisements may have a larger value than others, and in response to the user selecting the larger value advertisements, the user will reduce the costs associated with mailing the message by larger amounts.

As a result, a user may select the advertisements to “insert” in the message to reduce the amount of the costs associated with the mailing. Alternatively, in one embodiment, because the selected advertisements and their respective values are stored in tables, such as the ones described, the user only need to designate the group to which the message is to be sent, and the ad selector 74 automatically “inserts” the last selected advertisements stored within the exemplary tables 148, 162, 174, and 188 shown in FIGS. 10 and 11. These exemplary tables 148, 162, 174, and 188 may be stored in the ad compiler 66 (shown in FIG. 4).

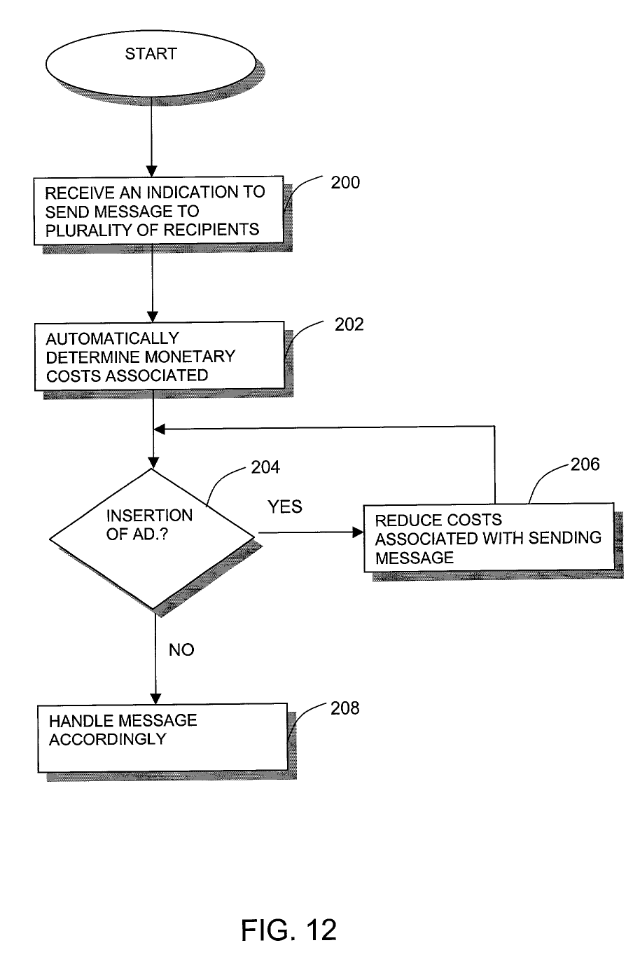

FIG. 12 illustrates the operational flow of the relevant aspects for supplementing the costs associated with mailing a message by inserting advertisements into the message, in accordance with one embodiment of the present invention. Operating in conjunction with the service pod 34, the ad compiler 66 receives an indication to send a message to a number of recipients 200. The ad compiler 66 determines the monetary costs associated with sending the message to the number of recipients 202, and in one embodiment, the monetary costs are determined from tables stored within the ad compiler 66.

Once the monetary costs associated with sending the message to the number of recipients is determined, the ad compiler 66 determines if an insertion of an advertisement with a monetary value associated with the advertisement is received. 204. If an insertion of the advertisement is received, the ad compiler 66 reduces the costs associated with mailing the message to the number of recipients by the monetary value associated with the inserted advertisement 206, and the ad compiler 66 continues to determine if further insertions are received, thereby further reducing the costs by the further inserted advertisements.

However, if it is determined that an insertion of an advertisement with a monetary value associated with the advertisement is not received, the ad compiler 66 operates in conjunction with the advertisement databases 68, 70, and ad counter 72 to determine which advertisements will be printed, as previously described.

As a result, a mailing system integrating the advantages of both the Internet and the Web (World Wide Web) with that of the more traditional mail services to improve the dissemination of information from a sender to a large number of recipients while supplementing the costs associated with the mailing transaction for the sender has been described.

While the present invention has been described in terms of the above illustrated embodiments, those skilled in the art will recognize that the invention is not limited to the embodiments described. The present invention can be practiced with modification and alteration within the spirit and scope of the appended claims. The description, is thus to be regarded as illustrative instead of restrictive on the present invention.

What is claimed is:

1. A method comprising:
receiving an indication to send a message to a plurality of recipients;
automatically determining a monetary cost associated with sending the message;
determining if an insertion of an advertisement of a selected one of a link to an advertisement of an advertiser and the advertisement itself, the advertisement having a monetary value associated with it, is received; and
automatically reducing the monetary cost associated with sending the message by the monetary value of the inserted advertisement, upon determining that the insertion is received.

2. The method of claim 1 further comprising automatically attaching one or more coupons to the message, based at least upon the inserted advertisement.

3. The method of claim 2, wherein the attached one or more coupons is at least one of an electronic coupon and a printable coupon.

4. The method of claim 1, wherein said receiving the indication comprises receiving a group selection.

5. The method of claim 1, wherein said automatically determining the monetary cost comprises automatically determining a monetary cost based at least in part on a number of the plurality of recipients.

6. The method of claim 1, wherein said automatically determining comprises automatically generating and displaying the monetary cost associated with sending the message to the plurality of recipients.

7. The method of claim 6, wherein said automatically generating comprises automatically generating an updateable window displaying the monetary cost.

8. The method of claim 1, wherein said receiving the insertion comprises automatically generating and displaying a selectable menu of a category of advertisers, the category based at least in part on attributes associated with the plurality of recipients.

9. The method of claim 1, wherein said receiving the insertion comprises receiving an insertion of a selected one of a link to an advertisement of an advertiser and the advertisement itself.

10. The method of claim 1, wherein said receiving the insertion comprises receiving an inputted category of an advertiser.

11. The method of claim 1, wherein said automatically reducing the monetary cost comprises automatically reducing the monetary costs by a monetary value of one or more inserted advertisements.

12. In a client device, a method comprising:
facilitating sending a message to a plurality of recipients included within a group;
facilitating receiving a monetary cost associated with sending the message;
facilitating insertion of a selected one of a link to an advertisement of an advertiser and the advertisement itself, in the message prepared by a sender, the advertisement having a monetary value associated with it; and
facilitating updating of the monetary cost associated with sending the message.

13. The method of claim 12 further comprising facilitating automatically attaching one or more coupons to the message, base at least upon the inserted selected one of the link to the advertisement of the advertiser and the advertisement itself.

14. The method of claim 13, wherein automatically attaching facilitation comprises facilitating automatic attachment of at least one of an electronic coupon and a printable coupon.

15. The method of claim 12, wherein said sending facilitation comprises facilitating selection of a single group, the group including the plurality of recipients.

16. The method of claim 12, wherein said sending facilitation comprises facilitation of automatic generation and displaying an e-mail messaging window.

17. The method of claim 12, wherein said receiving facilitation comprises facilitating automatic generation and displaying of the received monetary cost included within a cost window.

18. The method of claim 12, wherein said insertion facilitation comprises facilitating automatic arrangement of the link to the advertisement/the advertisement itself.

19. The method of claim 18, wherein said automatic arrangement facilitation comprises facilitating receiving an associated price for a position and size on a message page, the arrangement based at least in part on the price.

20. The method of claim 12, wherein said updating facilitation comprises facilitating receiving a reduced monetary cost, the received reduced monetary cost based at least in part on the value of the inserted link to the advertisement/the advertisement itself.

21. An apparatus comprising:
a storage medium having stored therein a plurality of programming instructions designed to receive an indication to send a message to a plurality of recipients, automatically determine a monetary cost associated with sending the message, determine if an insertion of an advertisement of a selected one of a link to an advertisement of an advertiser and the advertisement itself, the advertisement having a monetary value associated with it, is received, and automatically reduce the monetary cost associated with sending the message by the value of the inserted link to the advertisement/the advertisement itself, upon determining that the insertion is received; and
a processor coupled to the storage medium to execute the programming instructions.

22. The apparatus of claim 21, wherein the programming instructions are further designed to attach one or more coupons to the message, based at least upon the inserted advertisement.

23. The apparatus of claim 22, wherein the programming instructions are designed to attach at least one of an electronic coupon and a printable coupon.

24. The apparatus of claim 21, wherein the programming instructions are designed to receive a group selection.

25. The apparatus of claim 21, wherein the programming instructions are designed to automatically determine a monetary cost based at least in part on a number of the plurality of recipients.

26. The apparatus of claim 21, wherein the programming instructions are designed to automatically generate and display the monetary cost associated with sending the message to the plurality of recipients.

27. The apparatus of claim 26, wherein the programming instructions are designed to automatically generate an updateable window displaying the monetary cost.

28. The apparatus of claim 21, wherein the programming instructions are designed to automatically generate and display a selectable menu of a category of advertisers, the category based at least in part on attributes associated with the plurality of recipients.

29. The apparatus of claim 21, wherein the programming instructions are designed to receive an insertion of a selected one of a link to an advertisement of an advertiser and the advertisement itself.

30. The apparatus of claim 21, wherein the programming instructions are designed to receive an inputted category of an advertiser.

31. The apparatus of claim 21, wherein the programming instructions are designed to automatically reduce the monetary costs by a monetary value of one or more inserted advertisements.

32. An apparatus comprising:
a storage medium having stored therein a plurality of programming instructions designed to facilitate sending a message to a plurality of recipients included within a group, facilitate receiving a monetary cost associated with sending the message, facilitate insertion of a selected one of a link to an advertisement of an advertiser and the advertisement itself, in the message prepared by a sender, the advertisement having a monetary value associated with it, and facilitate updating of the monetary cost associated with sending the message; and
a processor coupled to the storage medium to execute the programming instructions.

33. The apparatus of claim 32, wherein the programming instructions are further designed to facilitate automatically attaching one or more coupons to the message, base at least upon the selected one of the link to the advertisement of the advertiser and the advertisement itself.

34. The apparatus of claim 33, wherein the programming instructions are designed to facilitate automatic attachment of at least one of an electronic coupon and a printable coupon.

35. The apparatus of claim 32, wherein the programming instructions are designed to facilitate selection of a single group, the group including the plurality of recipients.

36. The apparatus of claim 32, wherein the programming instructions are designed to facilitate automatic generation and displaying an e-mail messaging window.

37. The apparatus of claim 32, wherein the programming instruction are designed to facilitate automatic generation and displaying of the received monetary cost included within a cost window.

38. The apparatus of claim 32, wherein the programming instructions are designed to facilitate automatic arrangement of the link to the advertisement/the advertisement itself.

39. The apparatus of claim 38, wherein the programming instructions are designed to facilitate receiving an associated price for a position and size on a message page, the arrangement based at least in part on the price.

40. The apparatus of claim 32, wherein the programming instructions are designed to facilitate receiving a reduced monetary cost, the received monetary cost based at least upon the value of the inserted link to the advertisement/the advertisement itself.
